(19) United States
(12) Patent Application Publication
(10) Pub. No.: US 2007/0196239 A1
(43) Pub. Date: Aug. 23, 2007

(54) Optical nanowire biosensor based on energy transfer

(75) Inventors: Teunis Johannes Vink, Eindhoven (NL); Liesbeth Van Pieterson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/596,545

(22) PCT Filed: Dec. 7, 2004
(86) PCT No.: PCT/IB04/52686

§ 371 Date: Jun. 16, 2006

(30) Foreign Application Priority Data
Dec. 22, 2003 (EP) 03104907.5
Dec. 22, 2003 (EP) 03104900.0

(51) Int. Cl. G01N 21/00

(52) U.S. Cl. 422/82.05

(57) ABSTRACT

The present invention relates to the use of the optical properties of nanowires (1) for biomolecule (2) detection. The advantages of using nanowires (1) are a high specific surface area (1a) to bind receptor molecules (3) and size dependent optical properties because of strong quantum confinement of the carriers, i.e. nanowires (1) with different diameters show different colours. The proposed transduction mechanism is based on energy transfer between the biomolecule (2) and the nanowire (1) (or vice versa). Preferably, the target biomolecule (2) is a luminescent biomolecule (2), or said biomolecule (2) is labelled with a dye for quenching of the luminescence of the nanowire (1).

The present invention relates to methods and apparatus for detecting the presence and/or amount of biochemical or biological molecules, as well as biochemical or biological or chemical analysis.

The introduction of micro-arrays or biochips is revolutionising the analysis of DNA (desoxyribonucleic acid), RNA (ribonucleic acid) and proteins. Applications are e.g. human genotyping (e.g. in hospitals or by individual doctors or nurses), bacteriological screening, biological and pharmacological research.

Biochips, also called biosensor chips, biological microchips, gene-chips or DNA chips, consist in their simplest form of a substrate on which a large number of different probe molecules are attached, on well defined regions on the chip, to which molecules or molecule fragments that are to be analysed can bind if they are perfectly matched. For example, a fragment of a DNA molecule binds to one unique complementary DNA (c-DNA) molecular fragment. The occurrence of a binding reaction can be detected, e.g. by using fluorescent markers that are coupled to the molecules to be analysed. This provides the ability to analyse small amounts of a large number of different molecules or molecular fragments in parallel, in a short time. One biochip can hold assays for 1000 or more different molecular fragments. It is expected that the usefulness of information that can become available from the use of biochips will increase rapidly during the coming decade, as a result of projects such as the Human Genome Project, and follow-up studies on the functions of genes and proteins.

Whereas in a first generation of biochips that is now commercially available from e.g. Affymetrix, the substrate has only a support function, in future generations the substrate is expected to contain electronics that fulfil some or all detection and control functions (e.g. measurement of temperature and pH). This has the following advantages:
it makes the use of expensive and large optical detection systems unnecessary,
it provides the possibility to further enhance the areal density of probed molecules,
it enhances speed and accuracy,
it decreases the amount of test volume required, and
it decreases labour cost.

Biochips will become a mass product when they provide an inexpensive method for diagnostics, regardless of the venue (not only in hospitals but also at the other sites where individual doctors and/or nurses are present), and when their use leads to a reduction of the overall cost of disease management.

Nanowire-based nanosensors have recently been put forward for highly sensitive and selective detection of biological and chemical species. Nanowires are used as chemical gates in field effect transistor (FET) structures. Binding of a molecule to the surface of the nanowire can lead to the depletion or accumulation of carriers in the “bulk” of the nanowire and the accompanying changes in the conduction of the nanowire can be measured electronically.

In “Nanowire nanosensors for highly sensitive and selective detection of biological and chemical species” by Yi Cui, Qingqiao Wei, Hongkun Park and Charles M. Lieber, Science 293, 1289 (2001), it is demonstrated that boron-doped silicon nanowires with a functionalized surface can be used to detect pH, the protein streptavidin on a picomolar level, and Ca²⁺. In a first aspect described in this document a silicon nanowire (SiNW) solid state FET is transformed into a pH nanosensor by modifying the silicon oxide surfaces with 3-aminopropyltriethoxysilane (APTES) to provide a surface that can undergo protonation and deprotonation, where changes in the surface charge can chemically gate the SiNW. In a further aspect, biomolecular sensors are explored by functionalizing SiNWs with biotin. With this biosensors it is possible to study the well-characterised ligand-receptor binding of biotin-streptavidin. The nanosensors of the above document are capable of highly sensitive and selective real-time detection of proteins. Furthermore, in another example, a Ca²⁺-sensor is created by immobilising calmodulin onto SiNW devices for sensing Ca²⁺ ions which are important for activating biological processes such as muscle contraction, protein secretion, cell death.

The nanosensors as described above have some disadvantages in using nanowires as a chemical gate material. These relate to contacting the nanowires as well as assembly and positioning of the nanowires with respect to the contact structures. Furthermore, a CHEM-FET (Chemically Sensitive Field-Effect Transistor) has some intrinsic problems regarding sensitivity/specificity. Charged biomolecules present in the analyte will affect the charging state of the gate and thus set a limit to the sensitivity/specificity that can be achieved.

It is an object of the present invention to provide a method and device for the detection of biological, biochemical and/or chemical species that are sensitive and selective.

The above objective is accomplished by a method and device according to the present invention. In one aspect, the present invention relates to the use of optical properties of nanowires for biomolecule detection. A proposed transduction mechanism is based on energy transfer between the biomolecule and the nanowire.

The present invention provides a device for the detection of a molecule, e.g. in an analyte, and to output a signal in accordance with this detection. The device comprises at least one nanowire with a surface and having optical properties. The surface of the at least one nanowire is provided with at least one binding site able to selectively bind a molecule. The device furthermore comprises a photodetector for detecting the optical properties of the nanowire when the molecule selectively binds to the surface and for outputting the signal.

In one embodiment of the invention, the photodetector may be a phototransistor. The photodetector may, however, also be for example any suitable photodetector such as a photodiode, a photocathode or a photoconductor.

The molecule to be selectively bound may for example be a biomolecule or a biological organism. In an embodiment of the invention, the biomolecule may be a luminescent biomolecule with a first luminescence spectrum.

According to one aspect of the invention, the nanowire may have a second luminescence spectrum. The nanowire may be such that the first luminescence spectrum is different from the second luminescence spectrum. Furthermore, the at least one nanowire may comprise an activator ion.

In an embodiment of the present invention, the molecule to be selectively bound may be labelled with a dye.

Moreover, the device according to the present invention may comprise an array of nanowires. In an embodiment, at least a first nanowire may be modified with at least one first binding site and at least a second nanowire may be modified with at least one second binding site. The first and second binding sites may bind different molecules. In this way it is possible to detect more than one molecule at the same time with the same sensor device. Furthermore, the device may comprise at least two nanowires with different sizes.

In one embodiment of the present invention, the at least one nanowire may be dispersed in a liquid to form a suspension. The suspension of the at least one nanowire may be drop-deposited onto a surface.

In another embodiment, the at least one nanowire may be grown onto a surface. This surface may for example be a crystalline surface, which is required for epitaxial growth.

Furthermore, the at least one nanowire may be grown into a porous matrix.

The present invention furthermore provides a method for the detection of a molecule. The method uses the optical properties of at least one nanowire. In the method according to this invention, energy transfer between the molecule and the at least one nanowire, or vice versa, determines at least the presence of the molecule or if required an amount of the molecule present. In one embodiment, energy transfer may occur between a luminescent biomolecule, having a first luminescence spectrum, and at least one nanowire, having a second luminescence spectrum. According to the invention, the first luminescence spectrum may be different from the second luminescence spectrum. The biomolecule may be excited with light of an appropriate wavelength. In another embodiment, energy transfer may occur between the at least one nanowire having a luminescence and a dye the molecule is labelled with, whereby the luminescence of the nanowire is quenched. In still another embodiment of the invention, the dye or label may be used for energy transfer to the nanowire.

Using nanowires in the photodetection of biological and chemical species has several advantages. First, a high specific surface area is available to bind receptor molecules such as enzymes, antibodies or aptameres. A second advantage is the size dependent optical properties because of strong quantum confinement of the carriers, i.e. nanowires with different diameters show different colours. Thirdly, an optical detection method avoids the contact problems with the known electrically based nanowire sensors.

Furthermore, nanowires are relatively easy to handle, compared to for instance quantum dots. In the field of nanotechnology many low cost methods are being developed to prepare surfaces with arrays of nanowires in a controlled way.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

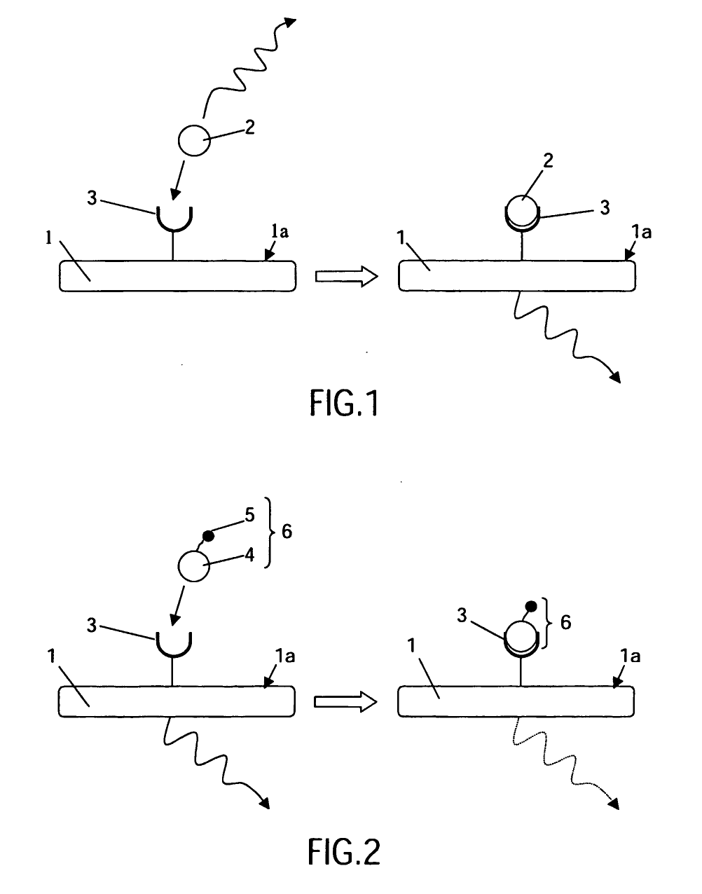

FIG. 1 is a schematic illustration of the detection method according to a first embodiment of the present invention.

FIG. 2 is a schematic illustration of the detection method according to a second embodiment of the present invention.

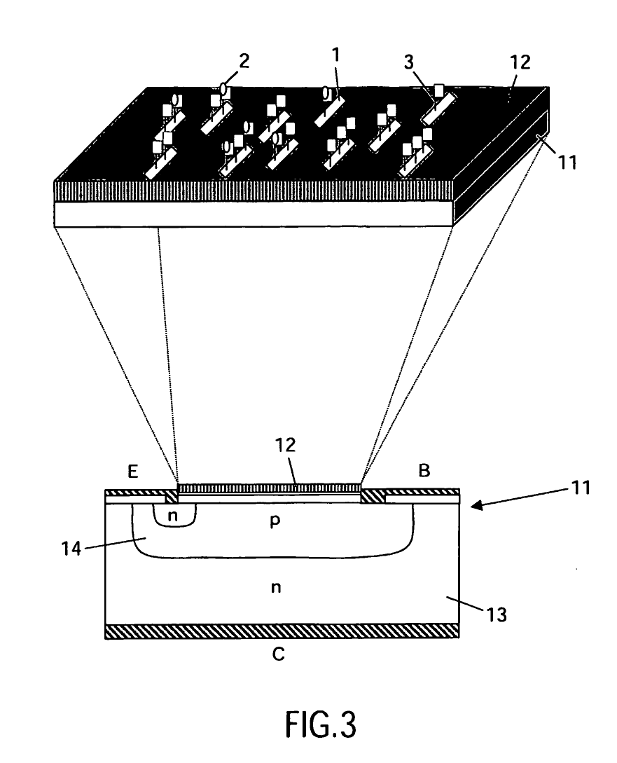

FIG. 3 is a schematic illustration of a device according to an embodiment of the present invention.

In the different figures, the same reference figures refer to the same or analogous elements.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The present invention provides a method and device for the detection of an analyte, such as for example a biological, biochemical or chemical species. The analyte will in this description further be referred to as a biomolecule as an example only of a suitable analyte for use with the present invention. Any biomolecule that can be coupled to a matrix is of potential use in this application. Examples are:
Nucleic acids : DNA, RNA: either double or single stranded, or DNA-RNA hybrids or DNA-Protein complexes, with or without modifications. Nucleic acid arrays are well known.
Proteins or peptides, with or without modifications, e.g. antibodies, DNA or RNA binding proteins, enzymes, receptors, hormones, signaling proteins. Recently, grids with the complete proteome of yeast have been published.
Oligo- or polysaccharides or sugars
Small molecules, such as inhibitors, ligands, cross-linked as such to a matrix or via a spacer molecule.

The method of the present invention uses the optical properties of a nanowire to detect the presence of an analyte such as a biomolecule. The proposed transduction mechanism in the method according to the present invention is based on energy transfer between the analyte, e.g. biomolecule and the nanowire (or vice versa).

Nanotechnology, or, as it is sometimes called, molecular manufacturing, is a branch of engineering that deals with the design and manufacture of extremely small devices such as electronic circuits and mechanical devices built at the molecular or macromolecular level of matter. There is a limit to the number of components that can be fabricated onto a semiconductor wafer or chip. Traditionally, circuits are produced via a so-called top-down approach, i.e. by the subsequent deposition and etching of layers. Alternatively, it is also possible to apply a so-called bottom-up approach using building blocks like carbon nanotubes, nanowires etc. and self-assembling techniques to construct devices on a nanometer size scale. In this way, devices with new functionalities (originating from electron-confinement effects) can be made. According to this invention, the focus is on nanowires that can be made from a conductive or semiconducting material. The aspect ratio of these nanowires is generally in the order of 100 or more (e.g. 10,000) while for instance rods and pillars (which are produced by a top-down approach) have generally an aspect ratio of 10 to maximum 100. In order to observe size dependent electron confinement effects the radius of the nanowire must typically be smaller than Bohr's radius of the exciton being 20 nm.

The nanowires may be grown by for example the so-called vapour-liquid-solid (VLS) growth method using a surface with for instance gold particles that act as catalytic growth centres, see Xiangfeng Duan and Charles, M. Lieber in Advanced Materials 12, 298 (2000). A broad range of binary and ternary III-V, Il-VI, IV-IV group elements can be synthesised in this way such as GaAs, GaP, GaN, InP, GaAs/P, InAs/P, ZnS, ZnSe, CdS, CdSe, ZnO, SiGe etc. The diameter of the nanowires may be controlled on a rough scale by the size of the catalytic Au particles. If needed, fine-tuning of the diameter of the nanowires may be achieved through photochemical etching, whereby the diameter of the nanowire is determined by the wavelength of the incident light during etching. The sensor area relative to the bulk is extremely high in the case of nanowire-based sensors, i.e. a lot of binding sites are available on the nanowire to achieve energy transfer. An alternative method of fabricating a set of semiconductor nanowires having a desired wire diameter (d) is disclosed in a corresponding patent application EP03104900.0, incorporated herein by reference. The alternative method comprises the steps of:
providing a set of pre-fabricated semiconducting nanowires (10′), at least one pre-fabricated semiconducting nanowire having a wire diameter (d′) larger than the desired wire diameter (d), and
reducing the wire diameter of the at least one pre-fabricated nanowire (10′) by etching, the etching being induced by electromagnetic radiation which is absorbed by the at least one pre-fabricated nanowire (10′), a minimum wavelength of the electromagnetic radiation being chosen such that the absorption of the at least one pre-fabricated nanowire being significantly reduced when the at least one pre-fabricated nanowire reaches the desired wire diameter (d).

In a first embodiment of the present invention, which is illustrated in FIG. 1, a first option to use the optical properties of a nanowire 1 to detect an analyte will be described. The surface la of the nanowire 1 is modified with at least one receptor 3. The receptor 3 may be surface, e.g. as defined by a biomolecule, that specifically recognises and binds the analyte that has to be detected. Such a biomolecule may for example be a polymer, an enzyme, an antibody or an aptamere.

In a first embodiment energy transfer between a target luminescent analyte such as a biomolecule 2 and the nanowire 1 or an activator ion (not shown in FIG. 1) present in the nanowire 1 provides a means of detection. The target luminescent biomolecule 2 may be excited with light of a first, appropriate, wavelength. When the target luminescent biomolecule 2 binds to the receptor 3 at the surface la of the nanowire 1, it may transfer its energy to the nanowire 1 or to the activator ion in the nanowire 1. Through this energy transfer, the nanowire 1 then emits radiation at a second wavelength. From this energy transfer from the target luminescent biomolecule 2 to be detected towards the nanowire 1, and thus from the radiation emitted by the nanowire 1, the presence of the target biomolecule 2 may be detected. Also a quantitative measurement of the amount of target biomolecule 2 may be made, e.g. from the amount of light emitted. The activator ion or the diameter of the nanowire 1 may be chosen such that the characteristic luminescent spectrum of the nanowire 1 occurs at a different wavelength compared to the luminescence wavelength of the target biomolecule 2, i.e. so that the first and the second wavelengths are different. In this way a high sensitivity may be achieved.

An advantage of this embodiment of the present invention is that no tagging nor labelling of the analyte is required and hence, a sensitivity in the order of picomolar (pM=10⁻¹² M) or even smaller is achievable.

The surface 1a of a nanowire 1 may be provided with one or more receptors 3, all receptors 3 on a nanowire being the same, but the receptors 3 being different for different nanowires 1. In that way, different sets of nanowires 1—receptors 3 may be made, each set linked with a specific target biomolecule 2 detecting function, and having a specific small band luminescent spectrum, optionally being different for different sets of nanowires 1—receptors 3, e.g. depending on the diameter of the corresponding nanowires 1. Use of a different set of nanowires 1—receptors 3 makes it possible to detect different analytes at the same time, both qualitatively and quantitatively using the method of the present invention.

In another embodiment of the present invention, not represented in the drawings, a parallel detector may be realised, comprising an array of nanowires 1 of which at least two are provided with different receptors 3 as described above. In this case, the different sets of nanowires 1 have a different specific small band luminescent spectrum. Such arrays of nanowires may for example be made by using an anodized aluminium substrate. Anodization creates a porous alumina film on the surface of Al with a regimented, hexagonal close-packed arrangement of nanopores, see S. Bandyopadhyay et al. Nanotechnology 7, 360 (1996). Into these pores nanowires can be grown, as is shown by for instance C. R. Martin in Chem. Mater. 8, 1739 (1996). After the deposition of the nanowires the porous alumina template can be selectively removed by wet chemical etching.

In this embodiment it is possible to detect different target biomolecules 2 at different wavelengths during one and the same measurement because a series of biomolecules 2 may be detected simultaneously by measuring a single luminescence spectrum of a nanowire-based array. A number of peaks corresponding to the number of bound analytes will be visible in the measured spectrum. The height of the peaks is a measure for the amount of each of the analytes present, and thus for the concentration.

In a further embodiment of this invention, illustrated in FIG. 2, another way of energy transfer is used for the detection of biomolecules 4. Here, energy transfer is based on target biomolecules 4 quenching the luminescence of the nanowire 1.

As in the first embodiment, the surface 1a of the nanowire 1 is modified by at least one receptor 3. The receptor 3 specifically recognises the target biomolecule 4 that has to be detected. The receptor 3 may for example be an enzyme, an antibody or an aptamere. In this embodiment, the biomolecules 4 may optionally be labelled with a dye 5 which may for example be a non-fluorescent quencher, such as e.g. QSY 7, QSY 9, QSY 21, QSY 35 available from Molecular Probes. The nanowire 1 has a characteristic luminescence spectrum. When the labelled biomolecule 6 binds to a specific site or to the receptor 3 on the surface 1a of the nanowire 1, it quenches the luminescence of the nanowire 1. As already mentioned, it is only optional to label the biomolecule 4. However, the quenching is most effective when the biomolecule 4 is labelled with a dye 5. In the latter case, appreciable overlap preferably exists between the emission spectrum of the donor (being the nanowire) and the absorption spectrum of the acceptor (being the dye), see P. T. Tran, E. R. Goldman, G. P. Anderson, J. M. Mauro, and H. Mattoussi in Phys. Stat. Sol. B 229, 427 (2002) for further details.

In analogy with the first embodiment, it is also possible to modify the surface 1a of different nanowires 1 with different receptors, leading to different sets of nanowire-receptor combinations. Each set of nanowire-receptor combinations is linked with a specific target biomolecule 2 detecting function and optionally has a specific small band luminescent spectrum, e.g. depending on the diameter of the nanowire 1. In that way it may be possible to detect different analytes using the method of the present invention, by using different sets of nanowire-receptor combinations.

Again, an array of nanowires 1 may be used in this embodiment. By modifying the surfaces 1a of the nanowires 1 with different receptors, different target biomolecules 4 may be detected at the same time, e.g. when using nanowires 1 with varying diameters and thus with different photoluminescent spectra.

An advantage of the method and device of the present invention is that, by using nanowires and optical methods as for example luminescence, complex device structuring as required in the prior art and contacting of nanowires are no longer needed. With the method of the present invention sensitivity problems associated with auto-luminescence of biomolecules may be circumvented.

Various additional embodiments for a nanowire-based biosensor are included within the scope of the present invention. For instance, nanowires 1 may be used in a homogenous solution/suspension. Nanowires 1 with different size, e.g. diameters, and coated with different receptors 3 may be dispersed in a liquid which is compatible with the analyte to be detected in terms of solvent type, pH, to form a suspension. This suspension may be added and thoroughly mixed with the analyte. The presence of the different target biomolecules in the analyte follows from the changes in the luminescent spectra of the nanowires 1.

Furthermore, in another embodiment, the nanowires 1 may be directly grown onto a surface. Depending on the crystalline nature of the substrate, nanowire growth may be random, i.e. there is no preferred orientation of the nanowires relative to the substrate surface, or the nanowires may be specifically oriented in the case of epitaxial growth.

In yet another embodiment, the nanowires 1 may be grown into a porous aluminium oxide matrix. After growth the matrix material may be selectively removed by etching, leaving a dense array of nanowires aligned perpendicularly to the substrate.

Furthermore, nanowires 1 may be fixed to a substrate to form a 2D-type detector or to a shaped substrate to form a 3D-type detector. Therefore, in one embodiment, the suspension of nanowires 1 may be drop-deposited onto a surface. In this way, a random network of nanowires is formed on the surface, which may be used as a sensor.

In a further embodiment of the invention, a device 10, comprising nanowires 1, is provided for the detection of a molecule 2, 4. The device 10, which is illustrated in FIG. 3, comprises a photodetector 11, a filter 12 and at least one nanowire 1, which may be modified with at least one receptor 3. It is to be noticed that FIG. 3 is only for the ease of explaining this embodiment and that it is not limiting for the invention.

A photodetector 11 is formed in a semiconductor substrate 13 that may comprise a well or recess 14. The photoconductor 11 may, in this embodiment, for example be a phototransistor. However, also other types of photodetectors 11 may be used, such as e.g. a photocathode, a photodiode or a photoconductor. On top of the photodetector 11 a filter 12 is positioned. According to this invention, specific filters 12 for light with a particular colour or wavelength may be used. In that way, only light with a relevant wavelength may passed through the filter 12 and all other, disturbing light may be removed.

On top of the filter 12, nanowires 1 may be deposited. The nanowires 1 may, for example, be drop-deposited onto the filter 12 from a suspension of nanowires 1. The nanowires 1 may be modified with receptors 3 as already discussed in the above-described embodiments. Again, the nanowires 1 may be modified with the same receptors 3 or with different receptors 3.

In one embodiment, which is illustrated in FIG. 3, the molecule to be detected may be a luminescent biomolecule 2. The luminescent biomolecule 2 may be excited with light of a first, appropriate wavelength. When the luminescent biomolecule 2 binds to the receptor 3, it may transfer its energy to the nanowire 1 or to the activator ion in the nanowire 1. Through this energy transfer, the nanowire 1 then emits radiation at a second wavelength. The emitted radiation at a second wavelength passes through filter 12 and may then be detected by the photodetector 11. The signal output of the photodetector 11 may be an indication of the presence of the luminescent biomolecule 2. Also a quantitative measurement of the amount of target biomolecule 2 may be made, e.g. from the amount of light emitted. In another embodiment (not shown in FIG. 3), the molecule 4 to be detected may be labelled with a dye 5. The nanowire 1 may have a characteristic luminescence spectrum. When the labelled biomolecule 6 binds to a specific site or to the receptor 3 on the surface 1a of the nanowire 1, it quenches the luminescence of the nanowire 1. The quenched luminescence of the nanowire 1 may pass through the specific filter 12 and may then be detected by the photodetector 11. Again, the output of the photodetector 11 may be an indication for the presence of a molecule 4. In may also be possible to make a quantitative detection of the molecules 4. The degree of quenching of the luminescence of the nanowire 1 may be a measure for the amount of molecules 4 present.

In still another embodiment of the invention, the device 10 may comprise 2 photodetectors 11, which both have on top a filter 12, which may both be the same or be different from each other, on which nanowires 1 are deposited. By using different filters, i.e. filters which are sensible for light with other wavelengths, the device 10 may operate at two different frequencies, and hence, different molecules 2, 4 may be determined at the same time.

It is to be understood that although preferred embodiments, specific constructions and configurations, as well as materials, have been discussed herein for devices according to the present invention, various changes or modifications in form and detail may be made without departing from the scope and spirit of this invention.

1. A device comprising at least one nanowire (1) with a surface (1a) and having optical properties, the surface (1a) being provided with at least one binding site (3) able to selectively bind a molecule (2, 4), and a photodetector (12) for detecting the optical properties of the nanowire (1) when the molecule (2, 4) selectively binds to the surface (1a) and for outputting a signal.

2. A device according to claim 1, wherein the photodetector (12) is a phototransistor.

3. A device according to claim 1, wherein the molecule (2, 4) is a biomolecule.

4. A device according to claim 3, wherein the biomolecule is a luminescent biomolecule, having a first luminescence spectrum.

5. A device according to claim 1, wherein the at least one nanowire (1) has a second luminescence spectrum.

6. A device according to claim 5, wherein the nanowire (1) is such that the first luminescence spectrum is different from the second luminescence spectrum.

7. A device according to claim 1, wherein the at least one nanowire (1) furthermore comprises an activator ion.

8. A device according to claim 1, wherein the molecule (2, 4) is labelled with a dye (5).

9. A device according to claim 1, wherein the device comprises an array of nanowires (1).

10. A device according to claim 1, wherein at least a first nanowire (1) is modified with at least one first binding site (3), and at least a second nanowire (1) is modified with at least one second binding site (3), the first and second binding sites (3) binding different molecules (2, 4) from each other.

11. A device according to claim 1, wherein at least two nanowires (1) have different sizes.

12. A device according to claim 1, wherein the at least one nanowire (1) is dispersed in a liquid to form a suspension.

13. A device according to claim 12, wherein the suspension of the at least one nanowire (1) is drop-deposited onto a surface.

14. A device according to claim 1, wherein the at least one nanowire (1) is grown onto a surface.

15. A device according to claim 1, wherein the at least one nanowire (1) is grown into a porous matrix.

16. A device according to claim 1, wherein the device is a nanowire sensor for the detection of an analyte (2, 4), wherein the at least one binding site (3) is able to selectively bind an analyte (2, 4), wherein the optical properties of the nanowire (1) are used for analyte (2, 4) detection.

17. A method for the detection of a molecule (2, 4), wherein the method uses optical properties of at least one nanowire (1), and wherein energy transfer between the molecule (2, 4) and the at least one nanowire (1), or vice versa, determines at least the presence of said molecule (2, 4).

18. A method according to claim 17, wherein energy transfer occurs between a luminescent biomolecule (2), having a first luminescence spectrum, and said at least one nanowire (1), having a second luminescence spectrum, said first luminescence spectrum being different from said second luminescence spectrum.

19. A method according to claim 18, wherein the luminescent biomolecule (2) is excited with light of an appropriate wavelength.

20. A method according to claim 17, wherein energy transfer occurs between the at least one nanowire (1) having a luminescence and a dye (5) the molecule (2, 4) is labelled with, whereby the luminescence of the nanowire (1) is quenched.

21. A method according to claim 17, wherein the molecule (2,4) is an analyte and energy transfer between the analyte and the at least one nanowire (1), or vice versa, determines the presence and/or amount of said analyte (2, 4).
